(19) United States
(12) Patent Application Publication
(10) Pub. No.: US 2015/0067436 A1
(43) Pub. Date: Mar. 5, 2015

(54) Nonvolatile Memory System Compression

(71) Applicant: SANDISK TECHNOLOGIES INC., PLANO, TX (US)

(72) Inventors: Xinde Hu, SAN JOSE, CA (US); LEE M. GAVENS, MILPITAS, CA (US)

(73) Assignee: SANDISK TECHNOLOGIES INC., PLANO, TX (US)

(21) Appl. No.: 14/016,954

(22) Filed: Sep. 3, 2013

(51) Int. Cl. G06F 11/10; G06F 12/02

(52) U.S. Cl. CPC G06F 11/1008; G06F 12/0238
USPC 714/758; 711/103

(57) ABSTRACT

Data to be stored in a nonvolatile memory array may be compressed in a manner that provides variable sized portions of compressed data, which is then padded to a predetermined uniform size and then stripped of padding. The encoded compressed data is sent to the memory array where it is stored in a uniform sized area that is exclusive to the encoded compressed data.

### BACKGROUND OF THE INVENTION

This invention relates generally to nonvolatile semiconductor memories, their formation, structure and use, and specifically to methods of operating nonvolatile memory systems in efficient ways.

There are many commercially successful non-volatile memory products being used today, particularly in the form of small form factor cards, which use an array of flash EEPROM cells. An example of a flash memory system is shown in FIG. 1, in which a memory cell array 1 is formed on a memory chip 12, along with various peripheral circuits such as column control circuits 2, row control circuits 3, data input/output circuits 6, etc.

One popular flash EEPROM architecture utilizes a NAND array, wherein a large number of strings of memory cells are connected through one or more select transistors between individual bit lines and a reference potential. A portion of such an array is shown in plan view in FIG. 2A. BL0-BL4 represent diffused bit line connections to global vertical metal bit lines (not shown). Although four floating gate memory cells are shown in each string, the individual strings typically include 16, 32 or more memory cell charge storage elements, such as floating gates, in a column. Control gate (word) lines labeled WL0-WL3 and string selection lines DSL and SSL extend across multiple strings over rows of floating gates. Control gate lines and string select lines are formed of polysilicon (polysilicon layer 2, or “poly 2,” labeled P2 in FIG. 2B, a cross-section along line A-A of FIG. 2A). Floating gates are also formed of polysilicon (polysilicon layer 1, or “poly 1,” labeled P1). The control gate lines are typically formed over the floating gates as a self-aligned stack, and are capacitively coupled with each other through an intermediate dielectric layer (also referred to as “inter-poly dielectric” or “IPD”) as shown in FIG. 2B. This capacitive coupling between the floating gate and the control gate allows the voltage of the floating gate to be raised by increasing the voltage on the control gate coupled thereto. An individual cell within a column is read and verified during programming by causing the remaining cells in the string to be turned on hard by placing a relatively high voltage on their respective word lines and by placing a relatively lower voltage on the one selected word line so that the current flowing through each string is primarily dependent only upon the level of charge stored in the addressed cell below the selected word line. That current typically is sensed for a large number of strings in parallel, thereby to read charge level states along a row of floating gates in parallel. Examples of NAND memory cell array architectures and their operation are found in U.S. Pat. Nos. 5,570,315, 5,774,397, 6,046,935, and 7,951,669.

Nonvolatile memory devices are also manufactured from memory cells with a dielectric layer for storing charge. Instead of the conductive floating gate elements described earlier, a dielectric layer is used. Such memory devices utilizing dielectric storage element have been described by Eitan et al., “NROM: A Novel Localized Trapping, 2-Bit Nonvolatile Memory Cell,” IEEE Electron Device Letters, vol. 21, no. 11, November 2000, pp. 543-545. An ONO dielectric layer extends across the channel between source and drain diffusions. The charge for one data bit is localized in the dielectric layer adjacent to the drain, and the charge for the other data bit is localized in the dielectric layer adjacent to the source. For example, U.S. Pat. Nos. 5,768,192 and 6,011,725 disclose a nonvolatile memory cell having a trapping dielectric sandwiched between two silicon dioxide layers. Multi-state data storage is implemented by separately reading the binary states of the spatially separated charge storage regions within the dielectric.

In addition to charge storage memory, other forms of nonvolatile memory may be used in nonvolatile memory systems. For example Ferroelectric RAM (FeRAM, or FRAM) uses a ferroelectric layer to record data bits by applying an electric field that orients the atoms in a particular area with an orientation that indicates whether a “1” or a “0” is stored. Magnetoresistive RAM (MRAM) uses magnetic storage elements to store data bits. Phase-Change memory (PCME, or PRAM) such as Ovonic Unified Memory (OUM) uses phase changes in certain materials to record data bits. Various other nonvolatile memories are also in use or proposed for use in nonvolatile memory systems.

### SUMMARY OF THE INVENTION

Data to be stored in a nonvolatile memory may be compressed and encoded prior to storage. Compression of units of data may be used to generate compressed data of variable length that is then padded with dummy data to restore it to the original size regardless of the length of the compressed data. Error Correction Code (ECC) encoding may then be performed on uniform sized units to generate redundancy data. Dummy data is then stripped, leaving compressed data and redundancy data, which are sent to a nonvolatile memory array, for example over a memory bus. In the memory array, a physical area with capacity to store an uncompressed unit of data (with redundancy data) is allocated exclusively for the compressed unit of data (with redundancy data) leaving some unused capacity. A system of incremented offsets may vary locations for storing such data in a physical area. Other schemes may be used to intersperse used and unused portions within a given physical area. In some cases, rather than leave the unused capacity unwritten, with memory cells in the erased state, some dummy data is written. When data is read, the scheme may be reversed, with compressed data being padded with dummy data, then decoded, then stripped of dummy data, and then decompressed. Thus, relatively little data is transferred over a memory bus, which is often a bottle neck in a nonvolatile memory system. Latency may be reduced, less power may be needed, and wear on cells caused by repeated write-erase cycles is reduced.

An example of a method of operating a nonvolatile memory system includes: receiving a portion of data; compressing the portion of data to obtain compressed data; padding the compressed data with dummy data so that the compressed data plus the dummy data forms a predetermined sized unit; encoding the predetermined sized unit to obtain redundancy data; subsequently stripping the dummy data and appending the redundancy data to obtain encoded compressed data; and sending the encoded compressed data to a nonvolatile memory die.

The method may further include: receiving the encoded compressed data in the nonvolatile memory die; and subsequently writing the encoded compressed data in nonvolatile memory cells of the nonvolatile memory die. The method may also include: reading the encoded compressed data from the nonvolatile memory; and sending the encoded compressed data from the nonvolatile memory die. The method may further include: receiving the encoded compressed data from the nonvolatile memory die; padding the encoded compressed data to form a predetermined sized unit; decoding the predetermined sized unit to obtain decoded data; stripping padding data from the decoded data to obtain decoded compressed data; and decompressing the decoded compressed data. The compressing, padding, encoding, stripping and appending may be performed in a memory controller that is connected to the nonvolatile memory die by a bus that carries the encoded compressed data. The portion of data may be a 4 KB portion, the predetermined sized unit may be a 4 KB sized unit, and the redundancy data may be approximately 512 Bytes. The encoded compressed data may be exclusively assigned to an area of the nonvolatile memory die that has a capacity equal to the predetermined sized unit plus the redundancy data. The nonvolatile memory die may include a plurality of areas that individually have capacity equal to the predetermined sized unit plus the redundancy data. The method may also include varying physical locations of encoded compressed data within individual areas of the plurality of areas. The varying of physical locations of encoded compressed data may include applying different offsets for starting locations of encoded compressed data in different areas.

An example of a nonvolatile memory controller may include: a data compression circuit that receives a portion of data of a predetermined size and generates compressed data; a data padding circuit that pads the compressed data with dummy data to generate padded compressed data having the predetermined size; a data encoder that encodes the padded compressed data to generate redundancy data; and a memory interface circuit that sends the compressed data and the redundancy data, without the dummy data, to a memory bus.

The memory bus may connect to at least one nonvolatile memory array and the compressed data and redundancy data may be exclusively assigned to an area of the nonvolatile memory array that is equal in size to the predetermined size plus the size of the redundancy data. The data compression circuit may apply lossless quantized compression to generate compressed data that consists of an integer number of multi-byte units of data. The data encoder may be a Low Density Parity Check (LDPC) encoder. The controller may also include: a data decoding circuit that receives compressed data and redundancy data from the memory interface circuit, adds dummy data, and performs decoding to obtain decoded data; a data stripping circuit configured to remove the dummy data from the decoded data; and a decompressing circuit configured to decompress the decoded compressed data.

Additional aspects, advantages and features of the present invention are included in the following description of examples thereof, which description should be taken in conjunction with the accompanying drawings. All patents, patent applications, articles, technical papers and other publications referenced herein are hereby incorporated herein in their entirety by this reference.

### BRIEF DESCRIPTION OF THE DRAWINGS

FIG. 1 is a block diagram of a prior art memory system.

FIG. 2A is a plan view of a prior art NAND array.

FIG. 2B is a cross-sectional view of the prior art NAND array of FIG. 2A taken along the line A-A.

FIG. 3 shows storage and recovery of data in a nonvolatile memory system.

FIGS. 4A-D show how data may be physically located in a nonvolatile memory array.

FIGS. 5A-B show an alternative way that data may be physically located in a nonvolatile memory array.

FIG. 6 illustrates threshold voltage levels corresponding to memory states.

FIG. 7 shows certain components of a memory system.

### DETAILED DESCRIPTION OF EXEMPLARY EMBODIMENTS

### Memory System

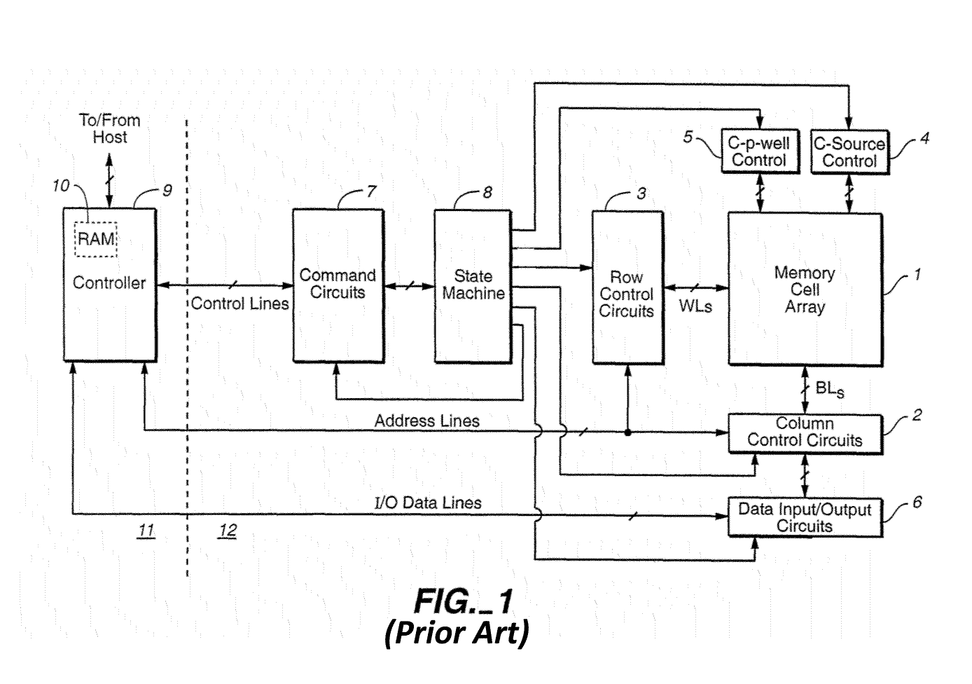

An example of a prior art memory system, which may be modified to include various aspects of the present invention, is illustrated by the block diagram of FIG. 1. A memory cell array 1 including a plurality of memory cells M arranged in a matrix is controlled by a column control circuit 2, a row control circuit 3, a c-source control circuit 4 and a c-p-well control circuit 5. The memory cell array 1 is, in this example, of the NAND type similar to that described above in the Background and in references incorporated therein by reference. A control circuit 2 is connected to bit lines (BL) of the memory cell array 1 for reading data stored in the memory cells (M), for determining a state of the memory cells (M) during a program operation, and for controlling potential levels of the bit lines (BL) to promote the programming or to inhibit the programming. The row control circuit 3 is connected to word lines (WL) to select one of the word lines (WL), to apply read voltages, to apply program voltages combined with the bit line potential levels controlled by the column control circuit 2, and to apply an erase voltage coupled with a voltage of a p-type region on which the memory cells (M) are formed. The c-source control circuit 4 controls a common source line (labeled as “c-source” in FIG. 1) connected to the memory cells (M). The c-p-well control circuit 5 controls the c-p-well voltage.

The data stored in the memory cells (M) are read out by the column control circuit 2 and are output to external I/O lines via an I/O line and a data input/output buffer 6. Program data to be stored in the memory cells are input to the data input/output buffer 6 via the external I/O lines, and transferred to the column control circuit 2. The external I/O lines are connected to a controller 9. The controller 9 includes various types of registers and other memory including a volatile random-access-memory (RAM) 10.

The memory system of FIG. 1 may be embedded as part of the host system, or may be included in a memory card, USB drive, or similar unit that is removably insertible into a mating socket of a host system. Such a card may include the entire memory system, or the controller and memory array, with associated peripheral circuits, may be provided in separate cards. Several card implementations are described, for example, in U.S. Pat. No. 5,887,145. The memory system of FIG. 1 may also be used in a Solid State Drive (SSD) or similar unit that provides mass data storage in a tablet, laptop computer, or similar device.

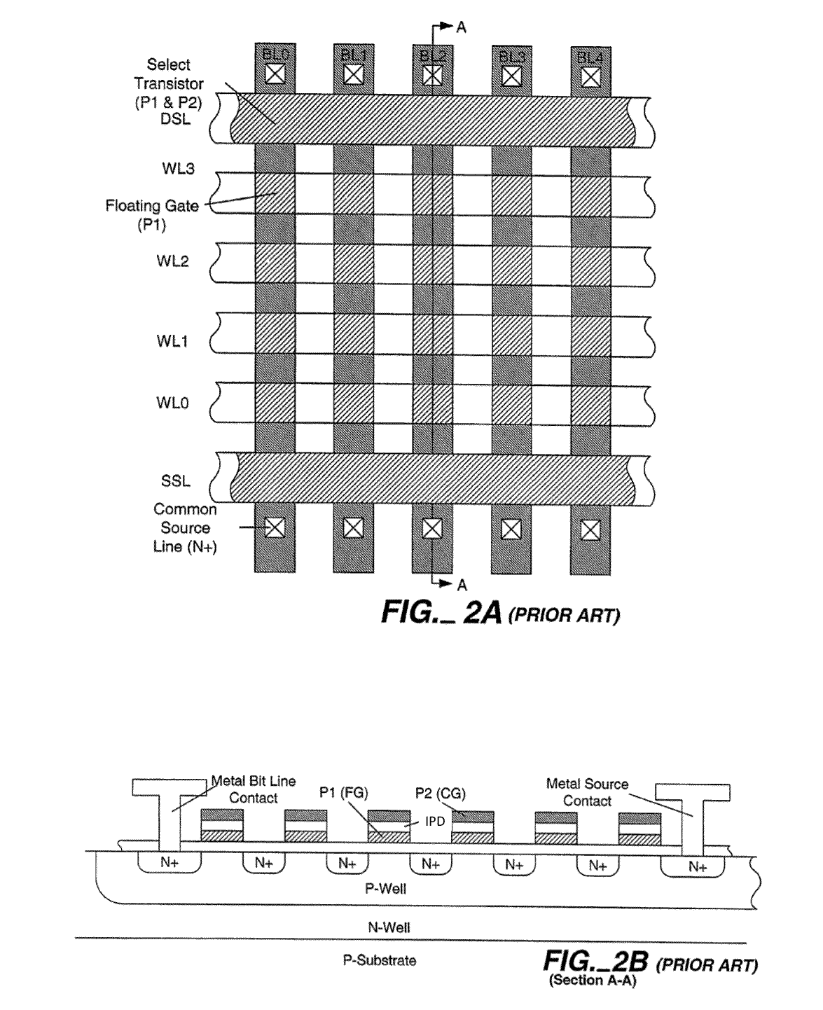

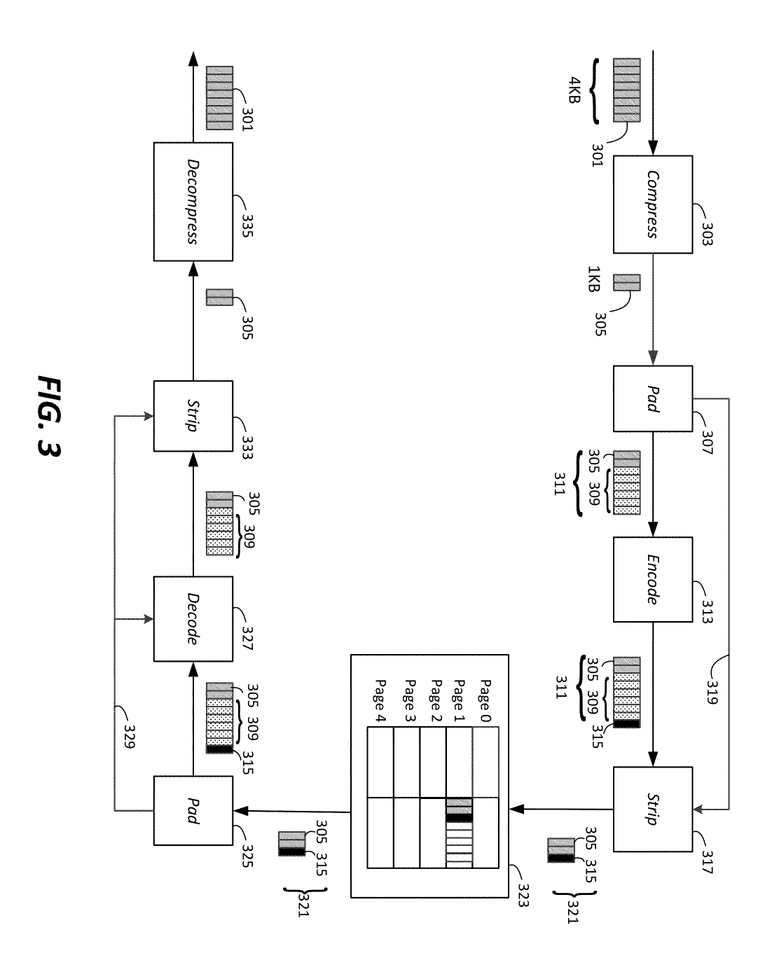

In addition to planar memories, such as shown in FIGS. 1 and 2, in which memory cells are formed in or on a surface of a substrate, there are various three-dimensional “3-D” memories in which memory cells are stacked in layers, one above another, extending up from a substrate. While such arrangements allow more memory cells to be formed on a given area of a substrate surface, this comes at the cost of additional complexity. Examples of such 3-D memory systems are described in U.S. Patent Publication Nos. 2013/0107628, and 2012/0220088.

### Encoding & Compression

Some memory systems perform Error Correction Code (ECC) encoding of data prior to storage of data in nonvolatile memory and then perform ECC decoding of the data after it is read from the nonvolatile memory. In this way, errors in the read data may be identified and corrected before the data is sent to a host. ECC encoding and decoding are often performed on a uniform sized unit of data (an ECC “word”) in a block encoding scheme. Redundancy data may be appended to the ECC word, in what may be considered a “system encoding” scheme.

In some memory systems, data may be compressed prior to storage, and decompressed when it is read from storage so that data occupies less space in the nonvolatile memory array. Examples of such compression are described in U.S. Pat. No. 7,529,905. Compression generally changes the size of a unit of data being handled, and may generate compressed data of variable size from fixed sized units of input data. Handling such variable sized data presents certain challenges.

One feature of many nonvolatile memories is that a page (the unit of reading and writing) has a fixed size that is determined by the physical design of the memory array. The size of a physical page may be chosen to hold an integer number of host units of data. When host units of data are compressed, the number of host units of data that can be stored in a page may be variable and may not be an integer number. Encoding variable sized units of data also requires an encoder that can handle such variable sized units. Thus, a simple block encoder is not compatible with such units.

According to an aspect of the present invention, compression is used to initially compress data that is received from a host. The compressed data is then padded with some dummy data (a predetermined pattern of data, which may be all Is, or all Os, or some other pattern). The padding is sufficient so that the size of the padded data is equal to an ECC word and can be encoded according to an ECC encoding scheme that uses a fixed-sized word. The size of the ECC word is generally the same as the unit sent by the host. ECC encoding is then performed to calculate redundancy data from the padded data. Subsequently, the dummy data is stripped from the encoded data, leaving just the compressed data and redundancy data. This encoded compressed data is then sent to a memory array for storage. This sequence may be reversed when the data is read from the memory array, with the data being padded with dummy data to a predetermined size for ECC decoding, then the decoded data being stripped of dummy data and decompressed.

There are several advantages to such a system. ECC encoding and decoding may be performed on uniform sized units so that the complexity of encoding variable sized units is avoided. Stripping of dummy data prior to sending the data to a memory array means that the amount of data being sent to the memory array is small. In many memory systems, a communication channel to a memory array is a bottle neck that impacts performance. For example, a memory bus between a memory controller, or Application Specific Integrated Circuit (ASIC), and one or more memory dies may limit performance of a memory system because of the large amount of data being transferred on such a bus. Reducing the data sent over such a bus may significantly reduce latency and improve performance.

In addition to reducing the amount of data sent to and from the memory array, there is less data to store in the memory array. This may reduce time required to store the data, power required to store the data, and reduce wear on memory cells.

FIG. 3 illustrates an example of how compression may be combined with ECC in an efficient manner. In this example, 4 KB is a unit of data sent by a host. It will be understood that aspects of the present invention are not limited to any particular sized unit of data and the present examples are for illustration only.

A 4 KB unit of data 301 is received and is subject to compression by a compression circuit 303. The 4 KB portion of data is represented as eight boxes in FIG. 3, so that each box represents 0.5 KB. It will be understood that this is approximate and individual boxes may correspond to sectors of 512 bytes, or similar units, resulting in slightly more than 4 KB in total. It will be assumed for this description that each such unit is a sector. The data may come from a host, through a host interface. In this example, the data is subject to lossless quantized compression in compression circuit 303 that generates 1 KB of compressed data 305. Quantized compression in this example means that the compressed data forms an integer number of sectors. Two sectors are generated from the original eight sectors in this example. However, a variable number of compressed sectors may be generated by such compression. For example, the next 4 KB unit might generate three sectors of compressed data, and the following one five sectors, etc. In some cases, no compression may be possible so that eight sectors are output from the compression operation for an eight sector input. The subsequent steps in this scheme do not depend on any particular number of compressed sectors being generated.

Compressed data 305 is sent to a padding circuit 307 where the data is padded by adding dummy data bits 309 so that the padded compressed data 311 has a predetermined size, in this case 4 KB. Thus, the size of the data unit is restored to the same size as the original uncompressed data 301. Padding may append a predetermined pattern of dummy bits. For simplicity, dummy data bits may be all logic 1, or all logic 0, or may be some pattern of logic 1 and logic 0. In this example, six sectors of dummy data are used to pad the two sectors of compressed data to generate eight sectors of padded compressed data. In other cases, a different number of sectors of dummy data may be added. For example, where five sectors of compressed data were generated, three sectors of dummy data would be needed. The amount of compressed data generated, or the amount of dummy data added, is recorded for later use (e.g. in a set of latches). The padded compressed data is then transferred to an encoding circuit.

The padded compressed data 311 is received by an encoding circuit 313, which may be an ECC encoding circuit using an ECC encoding scheme such as a Low Density Parity Check (LDPC) scheme, Reed-Solomon (RS) scheme, BCH scheme, Turbo code scheme, or other block encoding scheme. Because the padded compressed data 311 has been padded to be the size of an ECC word, the encoding circuit 313 can easily encode it according to any well-known block encoding scheme. Encoding generates some redundancy data, which in this example is one sector of redundancy data 315. In general, the more redundancy data generated the greater the number of errors that can be corrected. However, this comes at the expense of additional overhead. Aspects of the present invention are not limited to any particular level of redundancy and the example of one sector of redundancy data is for simplicity of illustration. The ECC scheme uses system encoding to simply append the redundancy data 315 to the padded compressed data 311 (as opposed to transforming the data in some way during encoding). Thus, the compressed data 305 and dummy data 309 remain the same after encoding, with redundancy data 315 simply appended as an additional sector. The padded compressed data 311 including the redundancy data 315 is then sent to a stripping circuit 317.

The stripping circuit 317 strips dummy data 309 to leave encoded compressed data 321, which is compressed data 305 and redundancy data 315. The amount of compressed data or dummy data may be communicated over a communication channel 319 from the padding circuit 307 to the stripping circuit 317 so that the correct amount of data is stripped. Thus, in this example, six sectors of dummy data 309 are stripped away to leave just two sectors of compressed encoded data 305 and one sector of redundancy data 315. This is less than the original eight sectors received prior to compression, and less than the nine sectors output by the ECC circuit. This smaller amount of data is then sent for storage in a memory array 323. For example, this data may be sent over a memory bus, such as a NAND bus in a NAND flash memory system such as a memory card, USB thumb drive, or SSD. Clearly, sending three sectors over a congested bus is generally preferable to sending nine sectors and may significantly reduce latency.

While FIG. 3 shows a separate compression circuit, padding circuit, encoding circuit, and stripping circuit, it will be understood that these circuits may be combined, and functions described may be performed by one or more circuits in various ways. Aspects of the present invention do not require a particular number of separate circuits. In some cases, these circuits are formed in an Application Specific Integrated Circuit (ASIC). In other examples, the functions are performed by configurable circuitry that is configured through firmware, for example a memory controller with a particular firmware version to perform the operations described. In some cases an encoding circuit may perform padding, and stripping of data so that separate padding and stripping circuits are not required (i.e. padding and stripping may be internal to an encoding circuit).

The encoded compressed data 321 may be stored in the memory array 323 in various ways. FIG. 3 shows a memory array in which a page can store two units of data of eight sectors each, plus redundancy data of one sector per unit, for a total of 18 sectors per page. Thus, the memory array has a physical design that allows uncompressed data to be stored with an integer number of encoded units per page. These units may be latched individually as they are received and then programmed together in parallel. In this example, because of compression, only three sectors are to be stored in an area with capacity for nine sectors. Instead of attempting to write every available portion of the nonvolatile memory array, in the present example, the three sectors received are exclusively assigned to a portion of the memory array that has capacity to store nine sectors (i.e. to store uncompressed data plus redundancy data). In this example, this nine-sector portion of the physical memory array is not used for any other data. No further write is allowed to this portion and the portion is considered fully written. Thus, capacity for six additional sectors in this portion goes unused.

By maintaining a uniform sized physical area for storage of each unit of data from the host, additional complexity of managing variable sized units in physical memory is avoided. Maintaining a uniform sized physical area allows for variable compression (including zero compression) and makes tracking of units of data easier (one eight-sector unit from a host maps to one nine-sector physical area in the memory array so there is a one-to-one mapping).

While the physical space allocated to a given unit, such as the eight sector unit described, may not be reduced in this example, the power consumed in programming may be significantly reduced. In some cases, the power needed to program memory cells increases directly with the number of memory cells. Thus, programming three sectors would take approximately one third of the power required to program nine sectors, a significant power saving.

A further benefit of this compression is reduced wear on any individual memory cell. For example, where three of nine sectors are written as above, this means that two out of three memory cells in the physical area are not programmed and do not need to be erased in a subsequent erase operation prior to reuse (i.e. they remain in the erased state throughout). Thus, where compressed data is stored in this manner, and wear is distributed across memory cells, individual memory cells are subject to fewer potentially-damaging operations and may show greater endurance. Thus, for a block with a given write-erase cycle count (“hot-count”), memory cells are less worn if data was compressed prior to storage than if it was not. Blocks may continue to operate at higher hot-counts in a memory system using compression than in a memory system that does not use compression because wear on individual cells may be less for a given hot-count.

After data is stored in a memory array, the data may be requested, for example, when a read command is received from a host. FIG. 3 shows the encoded compressed data 321 being sent from the memory array. It will be understood that the encoded compressed data 321 may contain some errors at this point because of programming errors, read errors, disturbance of data during storage, or otherwise. The data may be sent from the memory array 323 over a memory bus. The encoded compressed data 321 is received by a padding circuit 325 that adds dummy data 309 to bring the data to the size of an ECC word. The amount of compressed data, or the amount of dummy data added, is recorded. In this example, the stripping performed prior to sending the data to the memory array is reversed so six sectors are added to bring the total to nine sectors. The padded encoded data and redundancy data is then sent to a decoding circuit 327. The decoding circuit 327 then decodes the data, using redundancy data 315 to identify and correct any errors (up to some limit), thereby reversing the earlier encoding.

The decoding circuit 327 receives the nine sectors of data and applies a decoding scheme to reverse the earlier encoding. However, decoding may not be uniformly applied across all received data. According to an aspect of the present invention, the decoding circuit may apply a decoding scheme that assumes all dummy bits are correct, i.e. when looking for bad bits, the encoder concentrates on the compressed data 305 and the redundancy data 315, not the dummy data 309. This focuses decoding on the data that was stored in the memory array (and may have become corrupted) instead of the dummy data, which is simply a predetermined pattern of bits that is unlikely to include bad bits. A form of soft-input decoding may be used, with dummy bits having a high likelihood (which may be certainty, or near certainty) of being correct and with compressed data and redundancy data having a lower likelihood of being correct. Thus, in trying to find a solution, the decoder circuit looks primarily at bits that were stored in memory array 323 to see which bits to flip. Such focused ECC may allow correction of stored data with a relatively high Bit Error Rate (BER) for a given scheme (or allow use of less redundancy data, and thus less overhead, for a given BER). Information regarding the amount of dummy data is received from padding circuit 325 over a communication channel 329 so that the encoder can assign different likelihoods (e.g. Log Likelihood Ratios) to dummy data and stored data. After decoding, the decoded compressed data 305 and dummy data 309 is sent to a stripping circuit 333.

The stripping circuit 333 removes dummy data 309, thus reversing earlier padding by the padding circuit 325, to leave only the decoded compressed data 305. Information regarding the amount of dummy data to strip is provided over communication channel 329. The decoded compressed data 305 is then sent to a decompression circuit 335.

The decompression circuit 335 reverses the compression performed by the compression circuit 303 to generate decompressed data from compressed data 305. Thus, two sectors of decoded compressed data 305 are transformed into eight sectors of decompressed data 301. This is the same as the original data 301 that may be returned to a host or otherwise used.

While FIG. 3 shows two sets of circuits, the top circuits used prior to storage, and the bottom circuits used after storage. This is for clearer illustration, and it will be understood that these components may be combined. Thus, a single ECC encoding/decoding circuit may be used to transform data in either direction. Similarly, a single compression/decompression circuit may be used to transform data in either direction, and a combined padding/stripping circuit may pad or strip data. These circuits may be provided on a single chip such as an ASIC or memory controller chip. A single memory bus may be used for transmission of data between such a chip and the memory array.

### Physical Storage in Array

Data that is compressed and encoded for efficient transmission and storage may be stored in a number of ways. The example described above maintains dedicated uniform-sized areas of physical memory for each unit received, with each such physical area capable of storing an uncompressed unit of data. In one example, compressed data is simply written starting at the first location in a physical area. Thus, sectors of compressed data would generally be stored starting at the same physical locations each time an area is written. Some cells within such an area would experience high wear with others experiencing low wear.

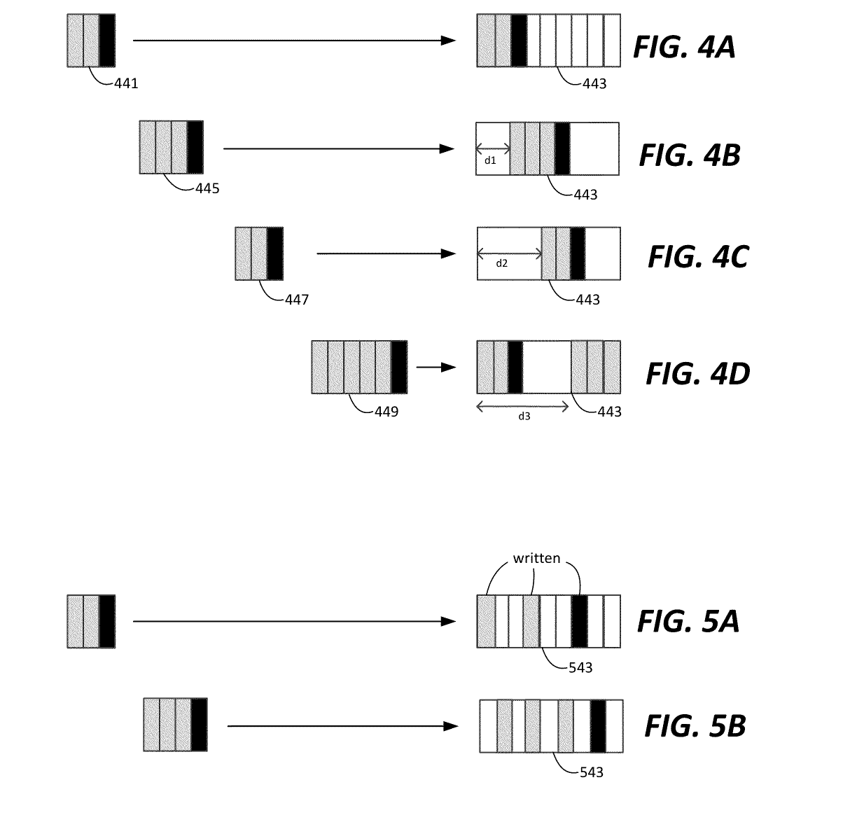

According to an aspect of the present invention, compressed data (and redundancy data) is stored using offsets to change the starting locations of stored data within allocated physical areas in which they are stored. FIG. 4A shows an example where a first portion of data 441 (two sectors of compressed and one sector of redundancy data corresponding to eight sectors of received data, as in the above example) is stored in a physical area 443 of a memory array that has capacity to store nine sectors. This portion of data is stored without any offset. Subsequently, this data may become obsolete and may be erased.

Subsequently, when a second portion of data 445 is stored in the physical area 443, an offset d1 is used so that it starts at a different location as shown in FIG. 4B. The offset d1 is two sectors in this example. However, any suitable offset may be used. Subsequently, when a third portion of data 447 is received, it is stored with an offset d2 of four sectors as shown in FIG. 4C. Subsequently, when a fourth portion of data 449 is received, it is stored with an offset d3 of six sectors. In this case, the portion of data 449 consists of six sectors (five sectors of compressed data and one sector of redundancy data) so that the data wraps-around and occupies both ends of the physical area 443, leaving the middle unwritten. Thus, the offset is incremented for each write to the physical area to prevent concentrating writes in any particular portion of the area. Such offsets may be applied in different ways, and for any suitable unit. In one example, the same offset is used for all writes to a block, with the offset being incremented each time the block is erased. Such an offset may be derived from a hot-count (write-erase cycle count) so that in a memory in which hot-counts are tracked, no separate tracking of offsets is required.

An alternative to a simple offset is shown in FIG. 5A, in which data is distributed according to a scheme that intersperses written and unwritten portions within a physical area 543. Thus, the written portions of an area are discontinuous, with unwritten portions in between. FIG. 5B shows a subsequent write to physical area 543, with written areas interspersed in a different pattern so that writing is distributed differently. A distribution scheme may be based on random distribution, or may distribute data in a physical pattern that depends on prior distribution (e.g. avoiding using areas that were used in the previous write), or on some indication of wear (e.g. reducing writes to areas with higher errors, longer programming time, or other indication of wear). While such a scheme may require additional overhead to track where data is stored, it may also allow data to be stored in a manner that reduces disturbance. For example, such a scheme may avoid storing data in particular patterns that may cause disturbance from cell-to-cell coupling.

While FIGS. 4A-D and 5A-B show certain portions of physical areas as written, and others as unwritten, in other examples it may be desirable to perform some programming of portions that would otherwise be unwritten because of reduced space required by compressed data. In particular in it may be desirable to program some dummy data in memory cells that are in close proximity to stored data. This may be particularly true in Multi Level Cell (MLC) memory, and in certain forms of three-dimensional (3-D) memory. In general, charge on a charge storage element (e.g. floating gate, or charge trapping layer) of one cell may affect threshold voltage of neighboring cells in addition to its own threshold voltage. Thus, the threshold voltage of a memory cell may be different depending on whether neighboring cells are written or unwritten. Leaving significant unwritten portions in an area of a memory array may affect stored data and may cause errors when it is read.

In an example, where data is compressed prior to storage in a uniformly sized physical area, and the compressed data does not occupy the entire area assigned to it, portions of the physical area that do not store compressed data may be programmed so that their memory cells have at least some charge. For example, some dummy data may be written in such areas.

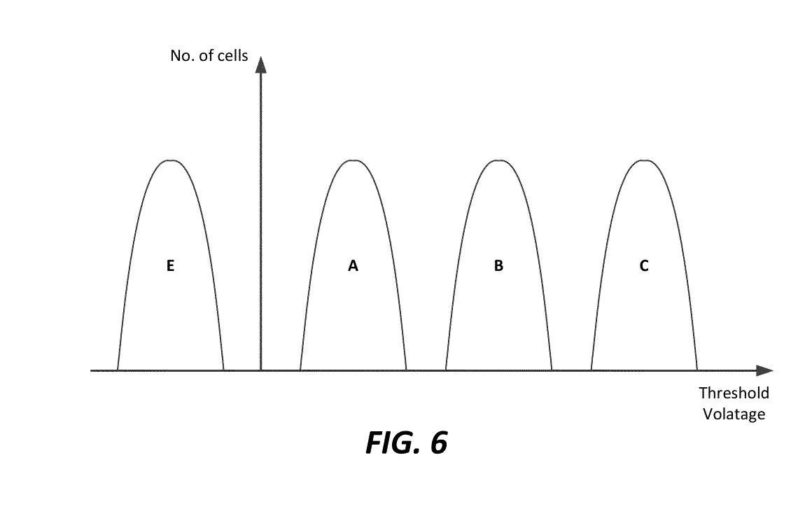

FIG. 6 shows four threshold voltage ranges associated with four different memory states in a two-bit-per-cell MLC memory. Unwritten cells remain in the erased “E” state, while programmed cells may be in E, A, B, or C states. Instead of leaving significant numbers of cells in the E state, a scheme may perform some programming of the cells so that they are raised to, for example, the A state or B state. While this may require some additional power, it may reduce cell-to-cell coupling and thus reduce the BER in read data. In some cases, such a programming scheme may be used in place of the offset scheme of FIG. 4 or the distribution scheme of FIG. 5 because programming such otherwise-unwritten cells avoids the uneven wear associated with leaving certain portions unwritten. In other cases, a combination of schemes may be used.

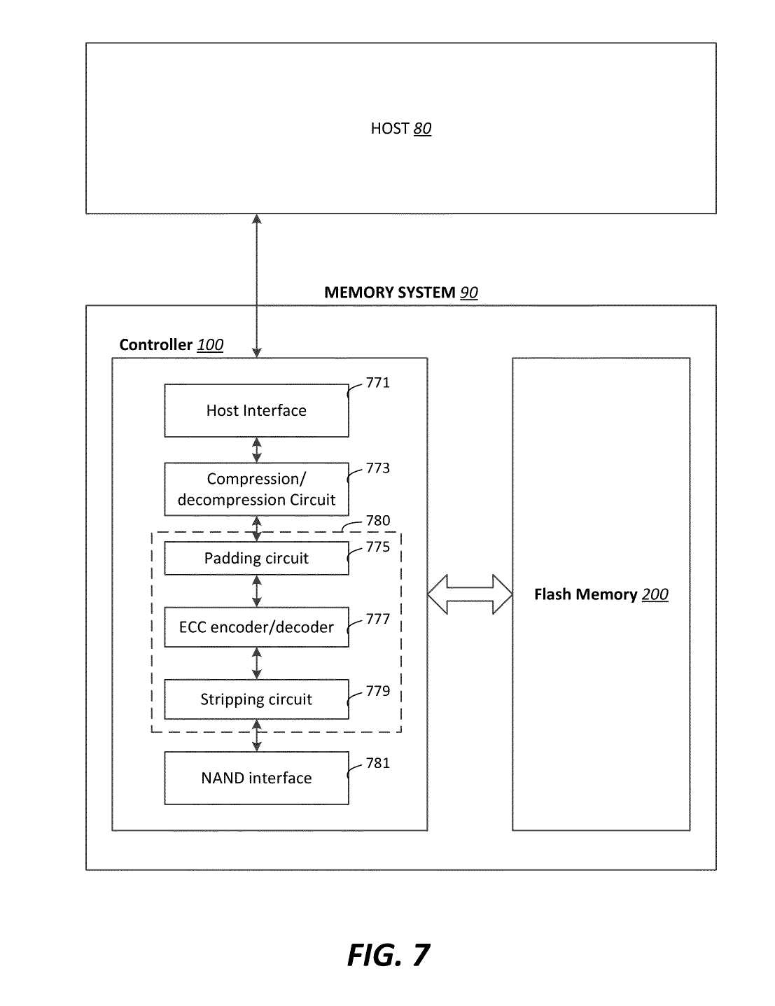

FIG. 7 shows an example of certain components of a nonvolatile memory system 90, which may be used to implement aspects of the present invention. Nonvolatile memory system 90 is connected to host 80. Nonvolatile memory system 90 includes a flash memory array 200 and a memory controller 100. Memory controller 100 includes a host interface 771 for communication with host 80. A compression/decompression circuit 773 is connected to the host interface 771. Units of data from host 80 are sent by host interface 771 to compression/decompression circuit 773 where they are compressed using lossless quantized compression so that a variable number of sectors of compressed data are generated. A padding circuit 775 adds an appropriate number of sectors of dummy data so that a full unit of data is provided. An ECC encoder/decoder 777 applies a block encoding scheme to the unit (which was padded to the size of an ECC word) to generate redundancy data. A stripping circuit 779 then strips the dummy data. Padding circuit 775, ECC encoder/decoder 777, and stripping circuit 779, may be considered as a single unit 780. A memory interface, NAND interface 781, sends the remaining data (compressed data and redundancy data) to the flash memory for storage. Subsequently, these circuits reverse this process when data is read (i.e. data is padded by padding circuit 775, decoded by ECC encoder/decoder 777, stripped by stripping circuit 779, then decompressed by compression/decompression circuit 773). It will be understood that memory controller 100 includes other circuits and that some or all of the circuits shown may be implemented through configurable circuitry that is configured through firmware.

### CONCLUSION

Although the various aspects of the present invention have been described with respect to exemplary embodiments thereof, it will be understood that the present invention is entitled to protection within the full scope of the appended claims. Furthermore, although the present invention teaches the method for implementation with respect to particular prior art structures, it will be understood that the present invention is entitled to protection when implemented in memory arrays with architectures than those described.

It is claimed:

1. A method of operating a nonvolatile memory system comprising:
receiving a portion of data;
compressing the portion of data to obtain compressed data;
padding the compressed data with dummy data so that the compressed data plus the dummy data forms a predetermined sized unit;
encoding the predetermined sized unit to obtain redundancy data;
subsequently stripping the dummy data and appending the redundancy data to obtain encoded compressed data; and
sending the encoded compressed data to a nonvolatile memory die.

2. The method of claim 1 further comprising:
receiving the encoded compressed data in the nonvolatile memory die; and
subsequently writing the encoded compressed data in nonvolatile memory cells of the nonvolatile memory die.

3. The method of claim 2 further comprising:
reading the encoded compressed data from the nonvolatile memory; and
sending the encoded compressed data from the nonvolatile memory die.

4. The method of claim 3 further comprising:
receiving the encoded compressed data from the nonvolatile memory die;
padding the encoded compressed data to form a predetermined sized unit;
decoding the predetermined sized unit to obtain decoded data;
stripping padding data from the decoded data to obtain decoded compressed data; and
decompressing the decoded compressed data.

5. The method of claim 1 wherein the compressing, padding, encoding, stripping and appending are performed in a memory controller that is connected to the nonvolatile memory die by a bus that carries the encoded compressed data.

6. The method of claim 1 wherein the portion of data is a 4 KB portion, the predetermined sized unit is a 4 KB sized unit, and the redundancy data is approximately 512 Bytes.

7. The method of claim 2 wherein the encoded compressed data is exclusively assigned to an area of the nonvolatile memory die that has a capacity equal to the predetermined sized unit plus the redundancy data.

8. The method of claim 7 wherein the nonvolatile memory die comprises a plurality of areas that individually have capacity equal to the predetermined sized unit plus the redundancy data.

9. The method of claim 8 further comprising varying physical locations of encoded compressed data within individual areas of the plurality of areas.

10. The method of claim 9 wherein the varying of physical locations of encoded compressed data comprises applying different offsets for starting locations of encoded compressed data in different areas.

11. A nonvolatile memory controller comprising:
a data compression circuit that receives a portion of data of a predetermined size and generates compressed data;
a data padding circuit that pads the compressed data with dummy data to generate padded compressed data having the predetermined size;
a data encoder that encodes the padded compressed data to generate redundancy data; and
a memory interface circuit that sends the compressed data and the redundancy data, without the dummy data, to a memory bus.

12. The nonvolatile memory controller of claim 11 wherein the memory bus connects to at least one nonvolatile memory array wherein the compressed data and redundancy data is exclusively assigned to an area of the nonvolatile memory array that is equal in size to the predetermined size plus the size of the redundancy data.

13. The nonvolatile memory controller of claim 11 wherein the data compression circuit applies lossless quantized compression to generate compressed data that consists of an integer number of multi-byte units of data.

14. The nonvolatile memory controller of claim 11 wherein the data encoder is a Low Density Parity Check (LDPC) encoder.

15. The nonvolatile memory controller of claim 11 further comprising:
a data decoding circuit that receives compressed data and redundancy data from the memory interface circuit, adds dummy data, and performs decoding to obtain decoded data;
a data stripping circuit configured to remove the dummy data from the decoded data; and
a decompressing circuit configured to decompress the decoded compressed data.
